(19) United States
(12) Patent Application Publication
(10) Pub. No.: US 2003/0018504 A1
(43) Pub. Date: Jan. 23, 2003

(54) Integrated material and information flow system

(76) Inventors: Yoshinobu Yamada, Redwood, CA (US); Thomas A. Branciforte, Clarkston, MI (US); Eric M. Ethington, Grand Blanc, MI (US); Margaret D. Bourne, Rochester, NY (US); Matt J. Zayko, Haslett, MI (US); Patricia Zavala, EI Paso, TX (US); Charles F. Knapp, Hamlin, NY (US)

Correspondence Address: Delphi Technologies, Inc., Mail Code 480414420, P.O. Box 5052, Troy, MI, 48007, US

(21) Appl. No.: 09/908,043

(22) Filed: Jul. 18, 2001

(51) Int. Cl. G06F 17/60; G06F 19/00

(52) U.S. Cl. 705/7

(57) ABSTRACT

An integrated material and information flow system employing a plurality of geographically-spaced receiving/distributing transfer hubs, each of which is responsible for receiving product from and supplying materials to an array of independent manufacturing and supplier sites. A two-way truck route connects each paired combination of hubs. Preferably, all materials are transported in dedicated, reusable containers. One or more truck routes in each hub region are followed among the sites linked to a given hub on a frequent and regular schedule, preferably daily. Each truck functions simultaneously to deliver to and to pick up from each site. Materials and empty containers to be delivered to a site responsible to a second or different hub are received at the first hub and are shipped to the second hub in a dedicated inter-hub shuttle vehicle. The flow of containers is regulated by a Kanban system employing twin Kanban information cards carried by the containers. The flow system eliminates long-distance shipping directly between sites in different hub regions; minimizes expenses, waste, and environmental load for non-reusable shipping and packaging materials; minimizes in-process inventories at all sites; and minimizes the total cost of transporting materials among all manufacturing and supplier sites.

### TECHNICAL FIELD

The present invention relates to systems for controlling the flow of materials in a manufacturing operation; more particularly, to systems for controlling the flow of components from various suppliers to various manufacturing site; and most particularly, to an integrated material and information flow system for efficiently managing the flow of components among a large number of suppliers and a large number of manufacturing sites, some of which may also be intermediate suppliers, via a system of interconnected hubs.

### BACKGROUND OF THE INVENTION

The efficient flow and control of components within a manufacturing system, the components being either manufactured internally as intermediates or obtained from outside suppliers, is an important and well-known field of study in production control and logistics in industrial engineering. Significant economies are obtained through time-based management of material flow, in costs of raw materials, work-in-process, and finished inventories. For example, the Japanese system using the Kanban, or “card-signal, is well known.

The Kanban is a simple parts-movement system that depends on cards (Kanbans) and boxes/containers to take parts from one work station to another on a production line. The essence of the Kanban concept is that a supplier or the warehouse should deliver components to the production line only as and when they are needed, so that there is no storage in the production area. Within this system, workstations located along production line produce or deliver desired components only when they receive a card and an empty container, indicating that more parts will be needed in production. Thus, the Kanban system limits the amount of inventory or work-in-process by acting as the authorization to produce more inventory. Since Kanban is a chain process in which orders flow from one process to another, the production or delivery of components is pulled by need along the production line, in contrast to the traditional forecast-oriented system where parts are pushed to the production line.

An “integrated” Kanban system uses two different kinds of cards: a “transport” Kanban and a “production” Kanban. The transport Kanban contains information as to where the part or component originated and its destination, whereas the production Kanban outlines to what extent and when work has to be accomplished by a specific station on the production line. The system may be used between a corporation and its suppliers: the corporations's transport Kanban regulates the supplier's production Kanban.

An integrated Kanban system is sometimes referred to as a “hub and spoke” system. It can function most efficiently when a plurality of suppliers independently feed a central production line, preferably from relatively short geographical distances, as tends to be the case in Japan, wherein transportation costs of materials and empty containers is a relatively small percentage of overall manufacturing costs.

In larger countries such as the United States, however, a single company may need to integrate the production activities of a large number of widely-separated manufacturing plants with the production of a very large number of widely-separated component suppliers. There may not be a manufacturing site central to its suppliers. Some of the manufacturing plants themselves may be suppliers of intermediate assemblies to other plants. A prior art Kanban approach can be very costly because a) common carrier shipping costs for returning containers to suppliers may be prohibitively expensive, and b) a large number of long trips may be required between suppliers and plants. In the prior art in the United States, the most cost-effective scheme in many applications has been to use one-way, non-reusable containers, and to ship one or a few components at a time by common carrier, typically on a pallet or skid and protected by non-reusable packaging materials.

It is a principal object of the present invention to provide a Kanban-type system for flow control of materials and production information.

It is a further object of the invention to provide such a system wherein transportation costs are minimized.

It is a still further object of the invention to provide such a system wherein raw materials, component, work-in-process, and finished goods inventories are minimized.

It is a still further object of the invention to provide such a system wherein non-reusable packaging materials are minimized.

### SUMMARY OF THE INVENTION

Briefly described, an integrated material and information flow system in accordance with the invention employs a plurality of geographically-spaced receiving/distributing hubs, each of which is responsible for receiving product from and supplying materials to an array of independent manufacturing and supplier sites. A two-way “pipeline” route (PPL truck route) connects each paired combination of hubs. Preferably, all materials are transported in dedicated, reusable containers. One or more truck routes in each hub region, referred to herein as “milk runs,” are followed among the sites responsive to a given hub on a frequent and regular schedule, preferably daily. Each truck functions simultaneously to deliver to and to pick up from each site. Materials and empty containers to be delivered to a site responsible to a second or different hub are received at the first hub from a milk run and are gathered there and then shipped to the second hub in a dedicated inter-hub shuttle vehicle. The flow of containers is regulated by a Kanban system employing information cards carried by the containers. Fully implemented, the flow system eliminates long-distance shipping directly between sites in different hub regions; minimizes expenses, waste, and environmental load for non-reusable shipping and packaging materials; minimizes in-process inventories at all sites; and minimizes the total cost of transporting materials among all manufacturing and supplier sites.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a schematic drawing of a prior art material and information network among a plurality of independent suppliers and a plurality of manufacturing sites of a single corporation;

FIG.2 is a schematic drawing of a material flow system in accordance with the invention;

FIG. 3 is a schematic drawing showing only a pair of hubs and associated sites of the system shown in FIG. 2, for simplifying discussion;

FIG. 4 is a schematic drawing of a manufacturing site internal information flow system in accordance with the invention, and how it relates to an exemplary supplier associated with a different hub; and

FIG. 5 is a schematic drawing showing the relationship of the information flow drawing shown in FIG. 4 to the materials flow drawing shown in FIG. 3 to form an integrated materials and information flow system in accordance with the invention.

### DESCRIPTION OF THE PREFERRED EMBODIMENTS

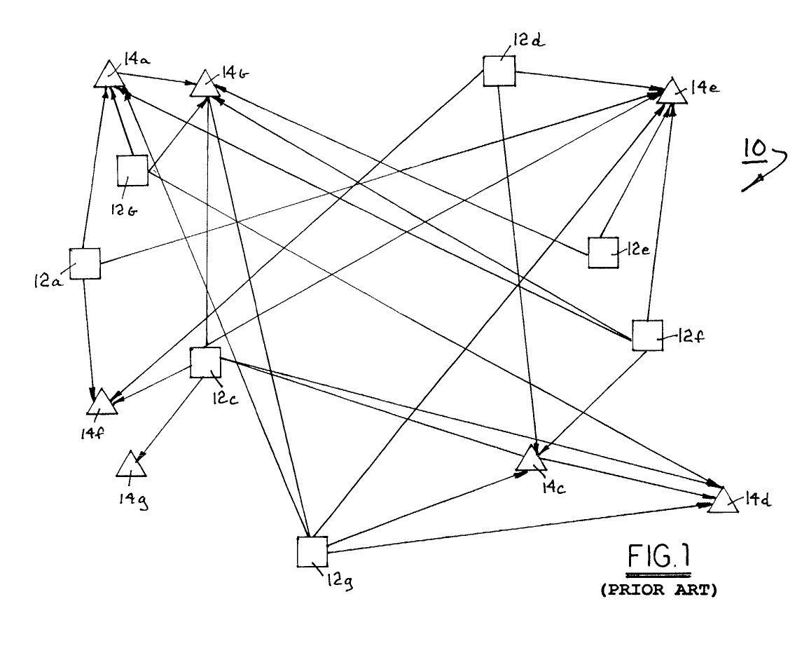

Referring to FIG. 1, a prior art material flow system 10 is shown, comprising a plurality of independent supplier sites 12a-12g (denoted by squares) and corporation manufacturing sites 14a-14g (denoted by triangles). Note that some sites 14 can also be suppliers (note arrows) of intermediate assemblies to other sites 14, as in 14a supplying 14b, and 14c supplying 14d. Note also that there are no return trips shown from sites 14 to suppliers 12. This is because, in general and especially for the long distance trips between manufacturing sites and suppliers which are far apart, return trips for the purpose of returning empty dedicated component containers would be prohibitively expensive. (In practice, some short-distance trips for returning empty containers may be justified, especially when the containers are easily stacked to increase the load density of containers.) Transportation is a non-value-added activity which is desirably minimized. Reusable component or materials containers are highly desirable as they can be custom designed for specific parts, can be ergonomically superior to non-reusables, can be more rigid, can stack better, etc. Because of return transportation costs, however, most components are shipped from suppliers to manufacturing sites via common carriers in one-way, non-reusable containers, typically with large amounts of packing, crating, wrapping, palleting, and the like.

The one-way non-reusable materials thus present a very substantial disposal problem for the manufacturing sites, as well as being economically wasteful and environmentally taxing. Dedicated or inhouse shipping by corporation vehicles is in general not justifiable because of the low volume of components being shipped at any one time. Such less-than-truck-full volumes are typically necessary, however, to optimize the just-in-time (JIT) relationship between supplier and manufacturing site and to minimize inventories at either end of the pipeline.

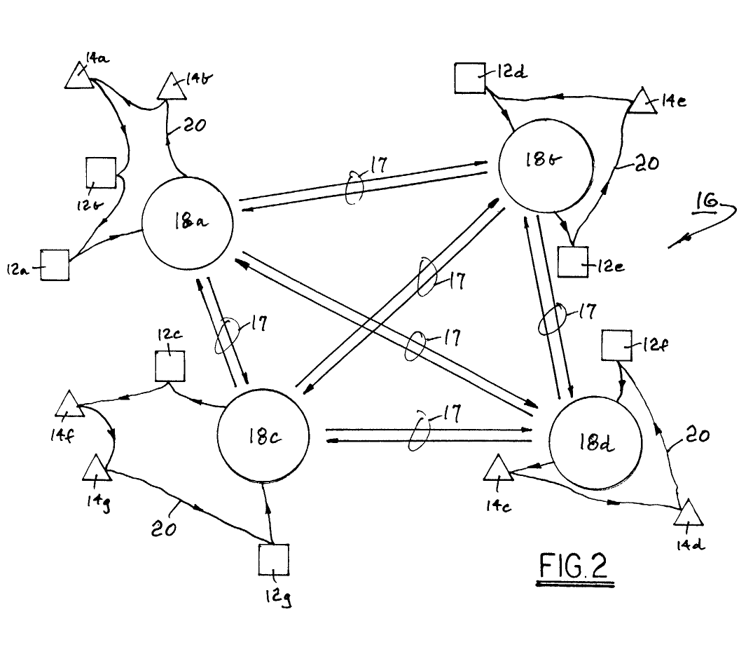

FIG. 2 shows a generalized schematic drawing of a “hub and loop” material flow system 16 in accordance with the invention. The same supplier sites 12 and manufacturing sites 14 are shown in their same geographic relationship as shown in FIG. 1. However, they are organized around four regional transfer hubs 18a-18d, and the supply to and delivery from each of sites 12 and 14 is a function of only one of hubs 18a-18d. Thus, all long-distance shipping directly between suppliers in any one region with manufacturing sites in any other region is eliminated. All such shipping is done instead via pipeline loops 17 (PPL) between regional hubs which collect and organize receivables from their own sites for shipment to other hubs and which receive and distribute shipments from other hubs to sites in their individual regions. This allows many small shipments from sites in one region, which formerly would have been shipped individually by common carrier, to be grouped into full truck loads and shipped by dedicated or inhouse carriers. Thus, trucking efficiency is maximized and unit shipping costs are minimized.

At each hub, a truck follows a standard route 20 on a regular basis, preferably at least daily, to collect the output of supplier sites. This pick-up loop (PUL), also referred to as a “milk run,” typically originates at the hub, or if necessary at one of the manufacturing sites, and visits several supplier sites in sequence. A PUL allows reusable containers between hubs, since a truck may deliver empty containers while picking up newly full containers. Preferably, such a route is less than about 300 miles per day, is run daily, and is organized such that the truck is at least 60% full of containers at some point in its route.

A complementary need is for a delivery loop (DL) whereby components received at the hub from other hubs are delivered to the manufacturing sites in the region. A DL also repeats on a regular schedule, the various deliveries being sequenced on the truck for expeditious unloading.

A third need is for a PUL for collecting the manufactured output of the manufacturing sites.

In many instances, and preferably, the PULs and the DL may be combined into a single PUL/DL milk run 20, or a number of such routes or variants at each hub. In some instances, the volume between a supplier and a hub or between a hub and a manufacturing site may be great enough to justify a dedicated PUL or DL for that site alone.

The combination of PPL, PUL, and DL routes allows use of reusable containers over the entire manufacturing system and also allows a Kanban-type materials tracking system to be superimposed on the materials flow system.

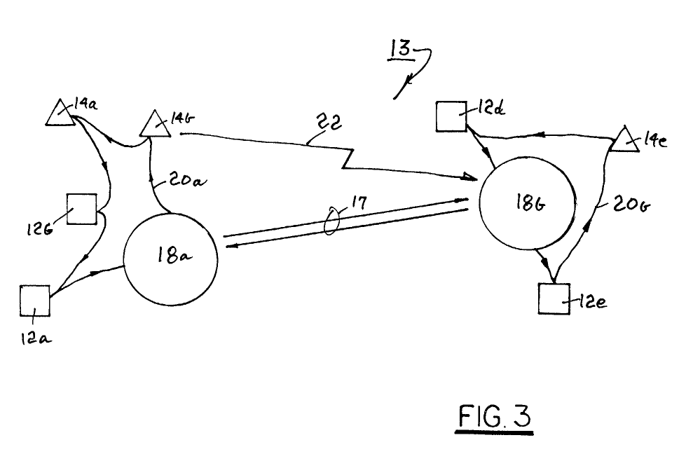

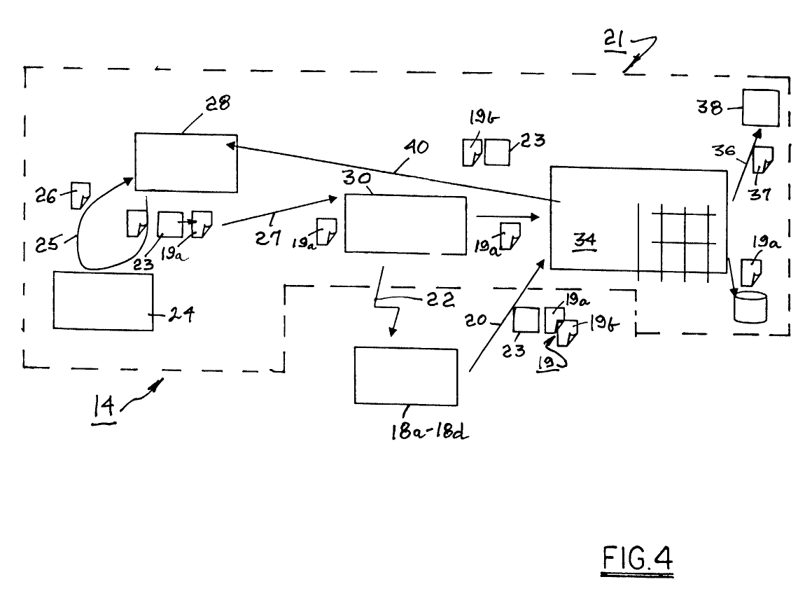

An example of how an “external” hub and loop flow system 13 for materials and control information may be operated between a manufacturing site and the hubs in the system is shown in FIGS. 3 and 4. (For simplicity in FIG. 3, only hubs 18a and 18b and manufacturing site 14b and supplier 12e are considered.) External refers to flow in the system external to the manufacturing site. In this example, site 14b electronically signals (22) hub 18b directly to request a shipment of material from supplier 12e. Hub 18b prints out an external Standard Information Packet 19 (Ext-SIP) which comprises two identical parts and represents a “hard” pull signal for supplier 12e. Preferably, Ext-SIP 19 includes machine-readable coded information regarding the material to be produced, the timing, and the supplier. Preferably, the code is a two-dimensional code (2D) readable by an optical comparator/reader in known fashion. Preferably, 2D-coded information is uploaded by the reader into a web-based materials tracking system. Hub 18b delivers Ext-SIP 19 to supplier 12e via a daily PUL milk run 20b. Supplier 12e produces the requested material and attaches Ext-SIP 19 to it. Preferably, the material is loaded in a reusable container 23 and the SIP is attached to the container. (For the remainder of this discussion, it is presumed that all material is transported in such containers.) The next PUL milk 20b run picks up the material and delivers it to hub 18b, which reads Ext-SIP 19, authorizes payment to supplier 12e, and cross-docks the material for delivery via the next PPL shipment to hub 18a. Hub 18a receives the shipment, reads Ext-SIP 19, and cross-docks and delivers the material to requesting site 14b via the next milk run 20a.

Referring to FIG. 4, within the manufacturing site a Kanban-type internal control system 21 is preferably used, as follows.

A manufacturing line or operation 24 consumes parts and sends an internal SIP 26 (Int-SIP, internal pull signal) to a parts inventory center 28 via an internal milk run 25.

Center 28 detaches old Ext-SIP 19a from a fresh container in stock, attaches Int-SIP 26, sends the fresh container with parts to manufacturing line 24 via milk run 25, and sends (27) old Ext-SIP 19a to a Production Control & Logistics center 30 (PC&L).

PC&L 30 orders materials based on the number of Int-SIPs received from inventory center 28 and transmits electronic order 22 to the appropriate hub or hubs 18a-18d which generates a new Ext-SIP (referred to hereinbelow as new Ext-SIP 19b) a described above for FIG. 3. PC&L 30 also places old Ext-SIP 19a on a tracking board 34 at the site receiving dock, at a location on the board signifying by what day and what carrier the next container should arrive. The material is ordered, produced, and shipped externally with new Ext-SIP 19b as described for FIG. 3. When the milk run 20 delivers the container containing the new shipment to the receiving dock at 14, the attendant receives the container, reads new Ext-SIP 19b, and removes ½ of the twin SIP and sends (36) the removed portion 37 to a site data processing center 38 where the new container is logged into the site to update the materials tracking status system. The dock attendant also removes and discards old Ext-SIP 19a from tracking board 34 thus indicating that the new container is no longer outstanding. The new container with the remaining ½ of new Ext-SIP is sent (40) to inventory center 28 where it is placed in readiness for demand by manufacturing line 24. New Ext-SIP now becomes an old Ext-SIP and the cycle begins anew.

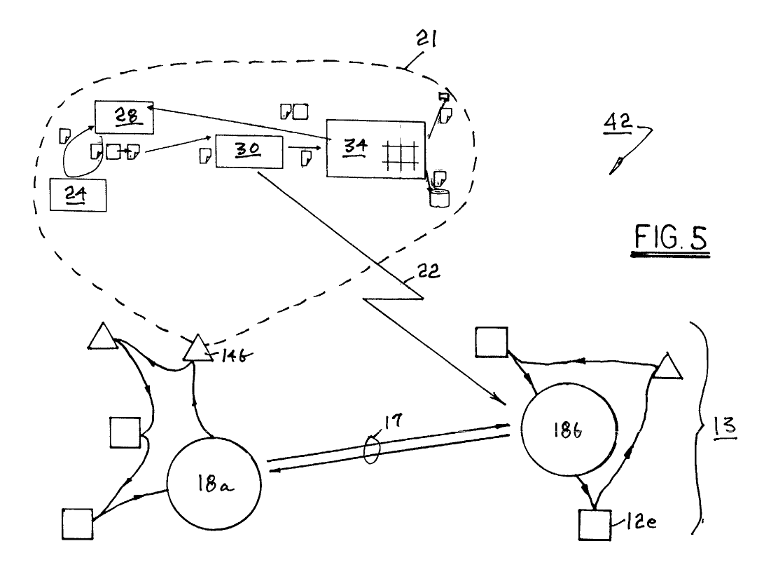

FIG. 5 shows the relationship of internal control system 21, shown in FIG. 4, to the materials flow system 13, shown in FIG. 3, the two systems forming an integrated material and information flow system 42 on accordance with the invention.

If an old Ext-SIP remains on the tracking board past its due date, it is a signal to PC&L 30 to backtrack along the supply route to determine and resolve the cause of the delay. If material is received without having an Ext-SIP attached, PC&L manages return of the material to the supplier. All other discrepancies as well are managed between PC&L and the supplier. Alternatively, the tracking functions may be performed electronically via readers and the 2D codes on Kanban cards 19.

Obviously, there are lead times built into each step of the system. Therefore, a number of Kanbans and containers are required for each type of material or specific component, the number being determined conventionally by a study of the materials flow.

Because the present system of the invention is a “pull” system in which suppliers respond to demand from the production line rather than a “push” from a central production planning function, little electronic communication is required between the manufacturing line and the hubs or the suppliers. PC&L forecasts production volumes broadly, as by week for a 16 week horizon, but otherwise the system automatically draws materials most efficiently through the supply channels with minimal in-process inventories of materials and components and with minimal transportation costs (maximized truck volume utilization) among suppliers and manufacturing sites.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for control of material flow in a manufacturing organization to minimize transportation costs and inventories of raw materials, work-in-process components, and finished goods among a plurality of spaced-apart supplier sites and a plurality of spaced-apart manufacturing sites within the manufacturing organization, comprising:
a) a plurality of spaced-apart regional transfer hubs for shipping and receiving materials, each of said supplier sites and said manufacturing sites being linked to one of said hubs;
b) a two-way vehicle route between at least two of said hubs;
c) a collection vehicle route originating and ending at one of said hubs for collecting materials from a plurality of suppliers linked to said one hub; and
d) a distribution vehicle route originating and ending at one of said hubs for distributing materials to a plurality of manufacturing sites linked to said one hub.

2. A system in accordance with claim 1 further comprising two-way vehicle routes between all combinations of hubs in said system.

3. A system in accordance with claim 1 further comprising collection and distribution vehicle routes at all of said hubs.

4. A system in accordance with claim 1 wherein at least one of said manufacturing sites is also a supplier to another of said manufacturing sites.

5. A system in accordance with claim 1 wherein at least one of said collection vehicle routes is also a distribution vehicle route.

6. A system in accordance with claim 1 further comprising a plurality of reusable containers for moving said materials from said supplier sites to said manufacturing sites.

7. A system in accordance with claim 6 wherein at least one of said distribution vehicle routes is also a route for collecting empty reusable containers from manufacturing sites.

8. A system in accordance with claim 6 wherein at least one of said collection vehicle routes is also a route for distributing empty reusable containers from a hub to supplier sites.

9. A system in accordance with claim 6 wherein said two-way vehicle is a route for transporting empty reusable containers between hubs.

10. A system in accordance with claim 1 wherein a vehicle follows said two-way vehicle route between hubs on a regular schedule.

11. A system in accordance with claim 10 wherein said schedule is at least once per day.

12. A system in accordance with claim 1 wherein a vehicle follows said collection vehicle route on a regular schedule.

13. A system in accordance with claim 12 wherein said schedule is at least once per day.

14. A system in accordance with claim 1 wherein a vehicle follows said distribution vehicle route on a regular schedule.

15. A system in accordance with claim 14 wherein said schedule is at least once per day.

16. A system in accordance with claim 1 further comprising a Kanban for identifying and traveling with said materials being shipped.

17. A system in accordance with claim 16 wherein said Kanban comprises two substantially identical parts.

18. A system in accordance with claim 6 further comprising a two-part Kanban attachable to at least one of said containers for identifying and traveling with said materials being shipped in said container.

19. A system in accordance with claim 18 wherein said Kanban is an External Kanban for identifying and traveling with said materials being shipped in said container between a supplier site and a manufacturing site.

20. A system in accordance with claim 18 further comprising an Internal Kanban for identifying and traveling with said materials being shipped within a manufacturing site.

21. A system in accordance with claim 19 wherein said External Kanban includes a two-dimensional information code.

22. A system in accordance with claim 20 wherein said Internal Kanban includes a two-dimensional information code.

23. A Kanban card bearing coded information about an associated amount of material wherein said Kanban card comprises two substantially identical portions having different tracking uses.
